(19) United States
(12) Patent Application Publication
(10) Pub. No.: US 2023/0003853 A1
(43) Pub. Date: Jan. 5, 2023

(54) DEVICE AND METHOD FOR GENERATING TEST DATA FOR TESTING A DISTANCE DETERMINATION IN AN OPTICAL TIME-OF-FLIGHT MEASUREMENT

(71) Applicant: Ibeo Automotive Systems GmbH, Hamburg (DE)

(72) Inventor: Ralf Beuschel, Friedrichshafen (DE)

(21) Appl. No.: 17/783,915

(22) PCT Filed: Sep. 25, 2020
(86) PCT No.: PCT/EP2020/076839

§ 371 Date: Jun. 9, 2022

(30) Foreign Application Priority Data
Dec. 11, 2019 (DE) 10 2019 219 330.7

(51) Int. Cl. G01S 7/497; G01S 7/4865; G01S 17/931

(52) U.S. Cl. CPC G01S 7/497; G01S 7/4865; G01S 17/931

(57) ABSTRACT

A device for generating test data for testing a distance determination during an optical runtime measurement, comprising:

A test pattern generator, which is set up to generate a chronological sequence of test events, so as to provide the latter to a test histogram channel for generating time-correlated test histogram data for testing the distance determination during the optical runtime measurement.

The present invention generally relates to a device for generating test data for testing a distance determination during an optical runtime measurement, a measuring device for testing a distance determination during an optical runtime measurement, and a method for generating test data for testing a distance determination during an optical runtime measurement.

Various methods for optical runtime measurement are generally known, which can be based upon the so-called time-of-flight principle, in which the runtime of a transmitted light signal that is reflected by an object is measured, so as to determine the distance to the object based upon the runtime.

Known for use in the automotive environment are sensors, which are based upon the so-called LIDAR (light detection and ranging) principle, in which pulses are periodically transmitted for scanning the environment, and the reflected pulses are detected. A corresponding method and a device are known from WO 2017/081294, for example.

LIDAR systems in the automotive environment must typically satisfy at least one safety requirement level according to ISO26262 ASIL B (D) during a distance determination, so as to enable autonomous driving functions. For this reason, safety analyses are usually performed that test various possible effects which can lead to a system malfunction.

Even if solutions for testing a distance determination during an optical runtime measurement are known from prior art, one object of the present invention is to provide a device for generating test data for testing a distance determination during an optical runtime measurement, a measuring device for testing a distance determination during an optical runtime measurement, and a method for generating test data for testing a distance determination during an optical runtime measurement.

This object is achieved by the device according to claim 1, the measuring device according to claim 10 and the method according to claim 15.

According to a first aspect, the present invention provides a device for generating test data for testing a distance determination during an optical runtime measurement, comprising:
A test pattern generator, which is set up to generate a chronological sequence of test events, so as to provide the latter to a test histogram channel for generating time-correlated test histogram data for testing the distance determination during the optical runtime measurement.

According to a second aspect, the present invention provides a measuring device for testing a distance determination during an optical runtime measurement, comprising:
A device according to the first aspect; and
At least one test histogram channel, which is set up to receive the chronological sequence of test events generated by the test pattern generator, and generate time-correlated test histogram data based thereupon.

According to a third aspect, the present invention provides a method for generating test data for testing a distance determination during an optical runtime measurement, comprising:
Generation of a chronological sequence of test events, so as to provide the latter to a test histogram channel for generating time-correlated test histogram data for testing the distance determination during the optical runtime measurement.

Additional advantageous configurations of the invention may be derived from the subclaims, the drawings and the following description of preferred exemplary embodiments.

As mentioned, some exemplary embodiments relate to a device for generating test data for testing a distance determination during an optical runtime measurement, comprising:
A test pattern generator, which is set up to generate a chronological sequence of test events, so as to provide the latter to a test histogram channel for generating time-correlated test histogram data for testing the distance determination during the optical runtime measurement.

As explained at the outset, LIDAR systems in the automotive environment must typically satisfy at least one safety requirement level according to ISO26262 ASIL B (D) during a distance determination, so as to enable autonomous driving functions. In such LIDAR systems, various causes of malfunctions during the distance determination can be present. For this reason, it is basically desirable to provide simple and reliable test methods for distance determination in LIDAR systems.

One possible cause for a malfunction during a distance determination during an optical runtime measurement, in particular during those based upon LIDAR, can involve a wrong timescale and/or a wrong time reference point of the system. A wrong timescale can result in incorrectly scaled distances; e.g., a wrong scaling factor that deviates by a factor of two can yield a result of 20 m instead of 10 m during a distance determination. In some exemplary embodiments, for example, a wrong timescale can be caused by an erroneous configuration of a time-to-digital converter (also referred to as “TDC”, time-to-digital converter). In other exemplary embodiments, an erroneous configuration of the data processing units can in turn be the cause. A wrong time reference point can result in a constant distance offset, e.g., 15 m instead of 10 m, 25 m instead of 20 m, etc. For example, a wrong time reference point in some exemplary embodiments can be caused by an incorrectly determined starting point for the optical runtime measurement. Another possible cause for a malfunction during the distance determination can involve a faulty data processing during a peak detection, which uses measuring data to determine a distance to an object that reflects the transmitted light.

For this reason, the device in some exemplary embodiments is used in a LIDAR system or the like, and for example utilized in the motor vehicle environment, without the invention being limited to these cases.

In some exemplary embodiments, generating test data can thus comprise generating electrical signals at various predefined times, which simulate a detection of reflected light during an optical runtime measurement.

In some exemplary embodiments, testing a distance determination can comprise comparing distances determined based upon the generated test data with nominal distances that were determined from the predefined times. In such exemplary embodiments, a deviation between the determined distances and the nominal distances can be an indicator for a malfunction during the distance determination.

This is advantageous in some exemplary embodiments, since it enables a routine verification of peak detection, so as to ensure an error-free functionality.

In some exemplary embodiments, the optical runtime measurement is based upon the so-called TCSPC (time correlated single photon counting) measurement principle, in particular in exemplary embodiments based upon LIDAR. Light pulses are here periodically transmitted, which typically are several nanoseconds long, and mark a starting point of a measurement. During the period until the next light pulse (measurement time), the light reflected by objects or backscattered light is detected by a light-detecting receiving element (e.g., a single photon avalanche diode (SPAD)), wherein light can likewise be detected in a short time range before transmitting the light pulses. The measurement time is here divided into a plurality of short time intervals (e.g., 30 ps). Each time interval can then have allocated to it a time that corresponds to a time distance from the starting time (e.g., given time intervals of 30 ps, a time of 15 ps can be allocated to a first time interval, and a time of 45 ps can be allocated to a second interval, etc.).

Depending on the distance to the object, the light reaches the light-detecting receiving element at different times. In the process, it generates an electrical signal in the light-detecting receiving element. Using a time-to digital converter (also referred to as “TDC”, time-to-digital converter), the electrical signal can then be allocated to one of the time intervals. Counting the electrical signals (“events”) that are allocated to a time interval gives rise to so-called histograms or time-correlated histograms (also referred to as TCSPC histograms), wherein these histograms can also be present only as pure data, for example, and stored as value pairs comprised of the time interval and accompanying number of entries (incidents or events), for example. Accordingly, the time intervals together with the number of events allocated to each time interval form histogram data, which basically can be represented by digital signals (or even analog signals). Such histogram data can be generated in a histogram channel. In general, LIDAR data in some exemplary examples can typically contain signal contributions from a backscatter, a light reflection on objects, ambient light, interference light signals from additional light sources in the environment, and the like.

In some exemplary embodiments, a test pattern generator can generate a chronological sequence of test events. In some exemplary embodiments, the chronological sequence can here have several electrical signals, which are generated at predefined times, wherein the electrical signals can correspond to the test events. In some exemplary embodiments, the generated chronological sequence of test events is synchronized with a starting time (time at which the light pulse is transmitted) of the optical runtime measurement, so that the distance determination can be tested parallel to a normal measurement. In other exemplary embodiments, the distance determination can be tested independently of a normal measurement (e.g., in the standby mode). The generated chronological sequence of test events can basically vary over time, i.e., one generated chronological sequence can differ from another generated chronological sequence. In such exemplary embodiments, the chronological sequence of test events can be generated based upon at least one input parameter, which are accessible to the test pattern generator. In some exemplary embodiments, the test events are identical, i.e., the electrical signals are identical, without the invention being limited in this regard. While the number of test events in the generated chronological sequence of test events is preferably constant, the number can vary from chronological sequence to chronological sequence in some exemplary embodiments.

The test pattern generator can here basically be electronic circuitry or an electronic circuit. The electronic circuitry can contain electronic components, digital storage elements, signal inputs (to receive analog and/or digital signals), signal outputs (to output analog and/or digital signals or electrical signals) and the like, so as to perform the functions described herein. In some exemplary embodiments, the electronic circuitry can be realized by an FPGA (field programmable gate array), DSP (digital signal processor), a microprocessor or the like. In some exemplary embodiments, the test pattern generator can here operate in the time domains with a resolution in the nanosecond range.

In some exemplary embodiments, a test histogram channel can generate time-correlated test histogram data. In some exemplary embodiments, Time-correlated histogram data comprise those data that are generated based upon the electrical signals of the light-detecting receiving elements within the (accompanying) measurement time. Analogously thereto, in some exemplary embodiments, time-correlated test histogram data are generated, which are generated based upon a generated chronological sequence of test events (electrical signals of the test pattern generator (generated chronological sequence of test events)), and used for testing a distance determination during an optical runtime measurement. In some exemplary embodiments, the test histogram channel can generate the time-correlated test histogram data based upon the generated chronological sequence of test events parallel to the normal measurement, without the invention being limited in this regard.

The test histogram channel can here basically have the same functionality and configuration as a normal histogram channel. In some exemplary embodiments, the test histogram channel can have a time-to-digital converter. The test histogram channel can here basically be electronic circuitry or an electronic circuit. The electronic circuitry can contain electronic components, digital storage elements, signal inputs (to receive analog and/or digital signals), signal outputs (to output analog and/or digital signals or time-correlated histogram data) and the like, so as to perform the functions described herein. In some exemplary embodiments, the electronic circuitry can be realized by an FPGA (field programmable gate array), DSP (digital signal processor), a microprocessor or the like.

In some exemplary embodiments, a time distance between two times of two chronologically sequential test events in the generated chronological sequence of test events is based upon a time resolution of the optical runtime measurement.

In some exemplary embodiments, a time resolution of the optical runtime measurement can correspond to a minimal time distance between two electrical signals (events), which can still be clearly differentiated. In some exemplary embodiments, the time resolution can be limited by the length over time of the electrical signals, which are generated by light-detecting receiving elements in response to an incidence of light. In other exemplary embodiments, the time resolution can be limited by a time-to-digital converter. In further exemplary embodiments, the time resolution can be limited by data processing.

In some exemplary embodiments, the time resolution must thus be considered while generating the chronological sequence of test events. In some exemplary embodiments, the time distance between two times of two chronologically sequential test events in the generated chronological sequence of test events can consequently be greater than the time resolution of the optical runtime measurement. The time resolution corresponds to a distance resolution of the optical runtime measurement over the speed of light.

In some exemplary embodiments, for example, the distance resolution (corresponds to time resolution) can measure 10 cm in a LIDAR system. In such exemplary embodiments, the time distance between two times of two chronologically sequential test events in the generated chronological sequence of test events can measure 50 cm, for example. As a result, a larger distance range can be tested during the LIDAR measurement.

In some exemplary embodiments, the chronological sequence of test events is further generated based upon at least one input parameter.

In some exemplary embodiments, the input parameters can be transmitted to the test pattern generator via signal inputs. For example, an input parameter can be an image counter, a line or column index, or a system time. The input parameters can basically be represented by analog and/or digital signals. In some exemplary embodiments, the number of test events and the times can thus be coded based upon the input parameters and correspondingly generated.

In other exemplary embodiments, the times of the chronological sequence can be coded externally in a hash generator based upon the input parameters. In such exemplary embodiments, for example, the coding can be present as a binary sequence (sequence of bits), and be transmitted via a signal input to the test pattern generator, which generates the chronological sequence of test events based upon the received binary sequence. In other exemplary embodiments, the hash generator can also be integrated into the test pattern generator. As a consequence, the input parameters are basically known or prescribed to the test pattern generator.

Generating the chronological sequence of test events based upon the input parameters allows the chronological sequence to resultantly change from time to time, so that a majority of possible times or time intervals viewed over a certain period of time can be tested. This makes it possible to test the entire system, discover malfunctions in the distance determination, and increase reliability.

As specified herein, a system for optical runtime measurement, in particular a LIDAR system, can in some exemplary embodiments have a receiving system, wherein each of the light-detecting receiving elements is set up to detect light, and in response thereto generate an electrical signal.

In some exemplary embodiments, the light-detecting receiving elements in the receiving matrix are arranged in columns and in lines (as generally known), wherein the same number of light-detecting receiving elements are provided in each line in some exemplary embodiments, without loss of generality.

In some exemplary embodiments, the receiving system comprises several histogram channels, wherein a respective histogram channel is connected with the light-detecting receiving elements in one column, or a respective histogram channel is connected with the light-detecting receiving elements in one line.

In some exemplary embodiments, each of the histogram channels is set up to generate the time-correlated histograms based upon the electrical signals of the light-detecting receiving elements.

In some exemplary embodiments, the input parameter is an image counter.

In some exemplary embodiments, an image counter can be the number of measurements performed up until this time. In such exemplary embodiments, a measurement corresponds to the transmission of one or several light pulses and the reception of time-correlated histogram data.

In some exemplary embodiments, the input parameter is a line index of a receiving matrix.

As mentioned above, a system for optical runtime measurement can have a receiving system with a receiving matrix. In such exemplary embodiments, the line index can correspond to a line of the receiving index.

In some exemplary embodiments, the input parameter is a system time.

In some exemplary embodiments, a system time can be a time of day that is set in the system for the optical runtime measurement. In other exemplary embodiments, the system time can be a time that elapsed since the commissioning of the system or in relation to other reference times.

In some exemplary embodiments, the device comprises a hash generator, which is set up to generate a bit vector from the input parameters, and apply a hash function to the latter, so as to generate a binary sequence.

In some exemplary embodiments, the hash generator can contain the input parameters, and generate a bit vector from the input parameters. In some exemplary embodiments, the bit vector can be a stringing together or merging of binary sequences, which represent the input parameters. In some exemplary embodiments, the hash generator can apply a generally known hash function to this bit vector, so as to generate a binary sequence. In such exemplary embodiments, the times of the chronological sequence of test events are coded, wherein the times clearly arise from the binary sequence. The number of bits of the bit vector is preferably larger (e.g., 64 bits) than the number of bits of the binary sequence (e.g., 8 or 16 bits), without the invention being limited to these cases.

The hash generator can here basically be electronic circuitry or an electronic circuit. The electronic circuitry can contain electronic components, digital storage elements, signal inputs (to receive analog and/or digital signals), signal outputs (to output analog and/or digital signals) and the like, so as to perform the functions described herein. In some exemplary embodiments, the electronic circuitry can be realized by an FPGA (field programmable gate array), DSP (digital signal processor), a microprocessor or the like. In some exemplary embodiments, the hash generator can be integrated into the test pattern generator.

In some exemplary embodiments, the chronological sequence of test events is thus further generated based upon the binary sequence, as explained above.

In some exemplary embodiments, the test events in the chronological sequence of test events are identical.

This is advantageous, since the corresponding electronic circuitry in the test pattern generator can be manufactured more cost effectively. In addition, the same relevance for testing the distance determination is ascribed to each test event in such exemplary embodiments.

Examples for coding the times of the chronological sequence of test events based upon the input parameters will be described below.

A first example for coding the times involves generating a binary sequence comprised of two bits, which are determined from a bit vector out of the input parameters via a hash function. Without loss of generality, the time distance between possible test events here corresponds to a distance of 1 m. No test event is generated at the starting time, and one synchronization event (first test event) is generated at 1 m. The two bits can then be used to code four more possible test events:
First bit=1, test event at 2 m;
First bit=0, test event at 3 m;
Second bit=1, test event at 4 m; and
Second bit=0, test event at 5 m;

A second example for coding the times involves considering the time resolution (distance resolution) of the system, an image counter, a line index and a synchronization event. For example, the time resolution of the system can be 10 cm. The time distance between two times can be 0.5 m, for example. Without loss of generality, a first test event is generated at 1 m (synchronization event). For example, the image counter can be used in calculating a modulo operation: Image counter mod 16. According to the obtained modulo, a second test event is generated in the distance range of 1.5 m-7.5 m, e.g., image counter mod 16=1 generates a second test event at 1.5 m, etc. For example, the line index in a receiving matrix can assume 100 values. According to the time index, a third test event can be generated in the distance range of 8 m-58 m. A distance displacement relative to the synchronization event can yield several distance ranges. The distance displacement can also be set relative to the preceding test event.

A third example for coding the times involves generating a binary sequence comprised of 16 bits, which is determined from a bit vector out of the input parameters via a hash function. The first 8 bits form a first hash vector, and the second 8 bits form a second hash vector. The time resolution of the system can be 10 cm, for example. The time distance between two times can be 0.5 m, for example. A synchronization event (first test event) is generated at 1 m. The first and the second hash vector each code 256 times. Accordingly, a second test event is generated in the distance range of 1.5 m-129.5 m, and a third test event in the distance range of 130 m-258 m.

Some exemplary embodiments relate to a measuring device for testing a distance determination during an optical runtime measurement, comprising:
A device as described herein; and
At least one test histogram channel, which is set up to receive the chronological sequence of test events generated by the test pattern generator, and generate time-correlated test histogram data based thereupon.

The measuring device can here basically be part of a system for optical runtime measurement, which is set up to test the distance determination of the optical runtime measurement. In some exemplary embodiments, there can be at least one test histogram channel for generating time-correlated test histogram data, so as to ensure a continuous testing of the distance determination.

In some exemplary embodiments, the test histogram channel provides the generated time-correlated test histogram data to a peak detection unit, which determines distances therefrom.

In some exemplary embodiments, for example, the peak detection unit can determine times or distances from time-correlated (test) histogram data based upon signal heights and/or signal shapes of various signal contributions, signal contribution times and/or the like, which is generally known. In some exemplary embodiments, the time-correlated test histogram data are analyzed by the peak detection unit like the time-correlated histogram data of a normal measurement. In some exemplary embodiments, the peak detection unit outputs the determined distances from the corresponding time-correlated (test) histogram data to a test unit.

The peak detection unit can here basically be electronic circuitry or an electronic circuit. The electronic circuitry can contain electronic components, digital storage elements, signal inputs (to receive analog and/or digital signals), signal outputs (to output analog and/or digital signals) and the like, so as to perform the functions described herein. In some exemplary embodiments, the electronic circuitry can be realized by an FPGA (field programmable gate array), DSP (digital signal processor), a microprocessor or the like. In additional exemplary embodiments, the peak detection unit is realized by a software, wherein the signal inputs in such exemplary embodiments correspond to the parameters/attributes of a software function/method. The determination of the distances then corresponds to the performance of a sequence of commands for performing specific computing operations on a computer, so that the distances are present after all commands have been executed. In some exemplary embodiments, the peak detection unit is also realized by a mixture of hardware and software-based components, to which the functionalities described herein are correspondingly distributed.

In some exemplary embodiments, the measuring device further comprises a test unit, which is set up to receive the distances determined by the peak detection unit and receive times of the chronological sequence of test events, so as to determine nominal distances from these times.

The test unit can here basically be electronic circuitry or an electronic circuit. The electronic circuitry can contain electronic components, digital storage elements, signal inputs (to receive analog and/or digital signals), signal outputs (to output analog and/or digital signals) and the like, so as to perform the functions described herein. In some exemplary embodiments, the electronic circuitry can be realized by an FPGA (field programmable gate array), DSP (digital signal processor), a microprocessor or the like. In additional exemplary embodiments, the test unit is realized by a software, wherein the signal inputs in such exemplary embodiments correspond to the parameters/attributes of a software function/method. The determination of the nominal distances then corresponds to the performance of a sequence of commands for performing specific computing operations on a computer, so that the distances are present after all commands have been executed. In some exemplary embodiments, the peak detection unit is also realized by a mixture of hardware and software-based components, to which the functionalities described herein are correspondingly distributed.

In some exemplary embodiments, the test unit can receive the determined distances (which were determined from the time-correlated test histogram data) from the peak detection unit at a signal input. In some exemplary embodiments, the test unit can receive the times of the chronological sequence of test events from the test pattern generator. In other exemplary embodiments, the test unit can receive the input parameters, and obtain the times of the chronological sequence of test events therefrom. In additional exemplary embodiments, the test unit can receive a binary sequence from a hash generator, and obtain the times of the chronological sequence of test events therefrom.

The test unit can determine nominal distances from the obtained times of the chronological sequence of test events. The nominal distances here correspond to the distances predefined by the times of the chronological sequence of test events. A deviation between the distances determined by the peak detection unit and the nominal distances makes it possible to infer a malfunction while determining the distance during the optical runtime measurement.

In some exemplary embodiments, the test unit is for this reason set up to generate an error signal based upon a deviation between the determined distances and the nominal distances.

The error signal can here indicate whether the deviation between the distances determined by the peak detection unit and the nominal deviation lies within a tolerance range. The tolerance range can have been determined experimentally, derived from experience, or from the system parameters (jitter, time resolution, etc.).

In some exemplary embodiments, the error signal is thus generated based upon a deviation that lies outside of a tolerance range.

Testing the distance determination of the optical runtime measurement based upon a chronological sequence of test events can uncover various malfunctions of the system, e.g.:
A faulty configuration of the timescale;
A faulty configuration of the distance scaling;
A faulty configuration or malfunction of the peak detection unit;
An incorrect time reference point; or
A false line index or image counter (e.g., repeated data).

Some exemplary embodiments relate to a method for generating test data for testing a distance determination during an optical runtime measurement, comprising:
Generation of a chronological sequence of test events, so as to provide the latter to a test histogram channel for generating time-correlated test histogram data for testing the distance determination during the optical runtime measurement.

Exemplary embodiments of the invention will now be exemplarily described with reference to the attached drawings, in which:

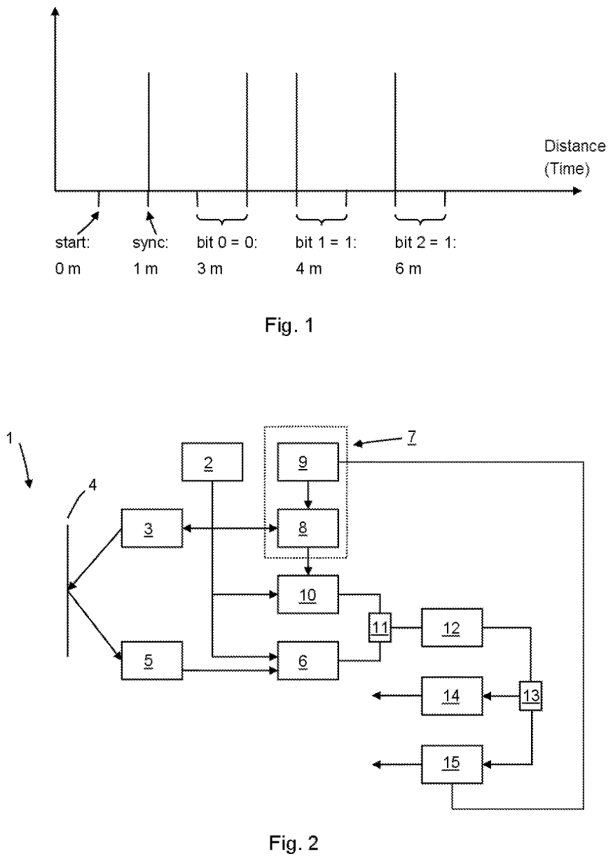

FIG. 1 illustrates a coding of times of a chronological sequence of test events;

FIG. 2 illustrates an exemplary embodiment of a system for an optical runtime measurement in a block diagram; and

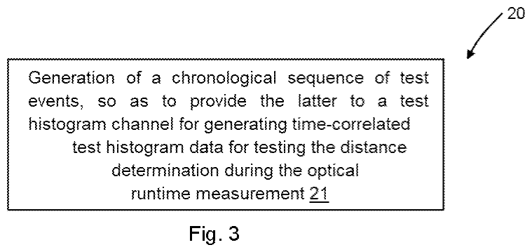

FIG. 3 illustrates an exemplary embodiment for a method of generating test data for testing a distance determination during an optical runtime measurement in a flowchart.

FIG. 1 illustrates the coding of times of the chronological sequence of test events.

The horizontal axis in the diagram on FIG. 1 is a distance (time). The vertical axis is dimensionless, and only serves to illustrate the times. The vertical dashes show the distance (point in time) at which a test event is generated.

In this exemplary embodiment, a binary sequence comprised of three bits is generated by a hash generator (not shown). The binary sequence was determined by applying a hash function to a bit vector, which was generated from an image counter and a line index. The first bit of the binary sequence is equal to 0, the second and third bit are each equal to 1. The time distance between the test events is constant, and corresponds to a distance of 1 m. No test event is generated at the starting point, and a synchronization event (first test event) is generated at 1 m. Based upon the binary sequence, a second test event is generated at 3 m, a third test event at 4 m, and a fourth test event at 6 m.

FIG. 2 illustrates the exemplary embodiment of system 1 for the optical runtime measurement in a block diagram.

The system 1 for the optical runtime measurement is a LIDAR system, and operates as follows: A pulse generator 2 outputs an electronic start signal for starting the optical runtime measurement. In response to the electronic start signal, a transmitting system 3 sends out a light pulse, which is reflected on an object 4. The reflected light reaches a receiving system 5, which has a receiving matrix (not shown) with light-detecting receiving elements (here SPADs) arranged in 128 lines and 256 columns. In response to the incident light, the light-detecting receiving elements generate electrical signals, which are received by a histogram channel 6. The histogram channel 6 also receives the electronic start signal for synchronization, and generates time-correlated histogram data based upon the received electrical signals.

A device 7 generates a chronological sequence of test events parallel to the optical runtime measurement. In this exemplary embodiment, the test events are identical, and generated at times according to FIG. 1. The device 7 receives the electronic start signal at a test pattern generator 8 for synchronization. The device 7 further has a hash generator, which generates the binary sequence from FIG. 1 based upon an image counter and a line index. The hash generator 9 transfers the binary sequence to the test pattern generator 8, which generates the chronological sequence of test events based upon the binary sequence. The latter is transferred by the test pattern generator 8 to a test histogram channel 10, which generates time-correlated test histogram data based upon the received chronological sequence of test events. The test histogram channel 10 receives the electronic start signal for synchronization.

In this exemplary embodiment, a switch 11 switches between the time-correlated histogram data and the time-correlated test histogram data once the image counter has again increased by four. If the switch 11 allows the time-correlated histogram data through, they are transferred to a peak detection unit 12, which determines object distances from the time-correlated histogram data. Another switch 13 switches the determined object distances to a processor 14, which generates a three-dimensional image of the object 4 from the object distances.

If the switch 11 allows the time-correlated test histogram data through, they are transferred to the peak detection unit 12, which determines distances from the time-correlated test histogram data. The switch switches the determined distances to a test unit 15. The test unit 15 receives the times of the chronological sequence of test events from the test pattern generator, and determines nominal distances therefrom. The test unit 15 compares the determined distances and the nominal distances, and outputs an error signal.

In a flowchart, FIG. 3 illustrates the exemplary embodiment for the method 20 of generating test data for testing the distance determination during the optical runtime measurement.

A chronological sequence of test events is generated at 21, so as to provide them to a test histogram channel for generating time-correlated test histograms for testing the distance determination during optical runtime measurement, as explained herein.

### REFERENCE LIST

1 System
2 Pulse generator
3 Transmitting system
4 Object
5 Receiving system
6 Histogram channel
7 Device
8 Test pattern generator
9 Hash generator
10 Test histogram channel
11, 13 Switch
12 Peak detection unit
14 Processor
15 Test unit
20 Method
21 Generation of a chronological sequence of test events, so as to provide the latter to a test histogram channel for generating time-correlated test histogram data for testing the distance determination during the optical runtime measurement

1. A device for generating test data for testing a distance determination during an optical runtime measurement, comprising:
A test pattern generator, which is set up to generate a chronological sequence of test events, so as to provide the latter to a test histogram channel for generating time-correlated test histogram data for testing the distance determination during the optical runtime measurement.

2. The device according to claim 1, wherein a time distance between two times of two chronologically sequential test events in the generated chronological sequence of test events is based upon a time resolution of the optical runtime measurement.

3. The device according to claim 2, wherein the chronological sequence of test events is generated based upon at least one input parameter.

4. The device according to claim 2, wherein the input parameter is an image counter.

5. The device according to claim 2, wherein the input parameter is a line index of a receiving matrix.

6. The device according to claim 2, wherein the input parameter is a system time.

7. The device according to claim 2, further comprising:
A hash generator, which is set up to generate a bit vector from the input parameters, and apply a hash function to the latter, so as to generate a binary sequence.

8. The device according to claim 7, wherein the chronological sequence of test events is further generated based upon the binary sequence.

9. The device according to claim 1, wherein the test events in the chronological sequence of test events are identical.

10. A measuring device for testing a distance determination during an optical runtime measurement, comprising:
A device for generating test data for testing a distance determination during an optical runtime measurement, said device comprising a test pattern generator, which is set up to generate a chronological sequence of test events, so as to provide the latter to a test histogram channel for generating time-correlated test histogram data for testing the distance determination during the optical runtime measurement; and
at least one test histogram channel, which is set up to receive the chronological sequence of test events generated by the test pattern generator, and generate time-correlated test histogram data based thereupon.

11. The measuring device according to claim 10, wherein the test histogram channel provides the generated time-correlated test histogram data to a peak detection unit, which determines distances therefrom.

12. The measuring device according to claim 11, further comprising:
A test unit, which is set up to receive the distances determined by the peak detection unit and receive times of the chronological sequence of test events, so as to determine nominal distances from these times.

13. The measuring device according to claim 12, wherein the test unit is further set up to generate an error signal based upon a deviation between the determined distances and the nominal distances.

14. The measuring device according to claim 13, wherein the error signal is generated based upon a deviation that lies outside of a tolerance range

15. A method for generating test data for testing a distance determination during an optical runtime measurement, comprising:
Generation of a chronological sequence of test events, so as to provide the latter to a test histogram channel for generating time-correlated test histogram data for testing the distance determination during the optical runtime measurement.
